(19) United States
(12) Patent Application Publication
(10) Pub. No.: US 2025/0226892 A1
(43) Pub. Date: Jul. 10, 2025

(54) SIGNAL PROCESSING SYSTEM

(71) Applicant: TAMAGAWA UNIVERSITY AND TAMAGAWA ACADEMY, Tokyo (JP)

(72) Inventors: Ken TANIZAWA, Tokyo (JP); Fumio FUTAMI, Tokyo (JP)

(73) Assignee: TAMAGAWA UNIVERSITY AND TAMAGAWA ACADEMY, Tokyo (JP)

(21) Appl. No.: 18/853,276

(22) PCT Filed: Feb. 21, 2023
(86) PCT No.: PCT/JP2023/006251

§ 371 Date: Oct. 1, 2024

(30) Foreign Application Priority Data
Apr. 4, 2022 (JP) 2022-062535

(51) Int. Cl. H04B 10/67

(52) U.S. Cl. CPC H04B 10/676

(57) ABSTRACT

The present invention addresses the problem of improving convenience in eavesdropping countermeasures in a physical layer. An optical transmission device 1 modulates laser light in accordance with a Y-00 protocol so that N-value transmit information (N=integer 2 or greater) corresponds to M symbol points (M=integer greater than or equal to N), and when an optical signal associated with prescribed symbol points is received, it is detected as being at the same position in an IQ plane as an optical signal associated with the other symbol points, and transmits the transmit information as an optical signal (cipher signal) with first strength. A cryptographic signal reception unit 21 receives in a transmission path 3, etc., an optical signal (cryptographic signal) having been attenuated from the first strength. The input unit of a beam splitter 144 modulates a laser in accordance with the Y-00 protocol for demodulation and acquires an optical signal. The beam splitter 144 and a balance PD 145 cause the optical signal having been attenuated from the first strength to be interfered with a laser-modulated optical signal. This configuration solves the abovementioned problem.

### TECHNICAL FIELD

The present invention relates to a signal processing system.

### BACKGROUND ART

In recent years, the importance of security countermeasures has been increasing in the communication of information. A network system that makes up the Internet is described by the OSI reference model, which has been formulated by the International Organization for Standardization. The OSI reference model is split into seven layers, from the layer 1 physical layer to the layer 7 application layer, and the interfaces that connect respective layers are either de facto standardized or are standardized through a standards body. The lowest layer from among the seven layers is the physical layer which is responsible for actual transmission and reception of signals by wire or wirelessly. Presently, the security countermeasures are implemented at layer 2 and above relying on mathematical ciphers in many cases, and the security countermeasures are not performed in the physical layer. However, there is the risk of eavesdropping in the physical layer. Specifically, for example, in optical fiber communication which is representative of wired communication, it is possible in principle to introduce a branch into an optical fiber, and extract some of the signal power to thereby steal large amounts of information in one occasion. Accordingly, the present applicant is developing a predetermined protocol given in Patent Document 1, for example, as an encryption technique for the physical layer.

### CITATION LIST

### Patent Document

Patent Document 1: Japanese Unexamined Patent Application, Publication No. 2012-085028

### DISCLOSURE OF THE INVENTION

### Problems to be Solved by the Invention

In the conventional technique including Patent Document 1 described above, transmission information (plaintext data or the like as a transmission target) is transmitted as a multi-level optical signal according to a predetermined protocol so that countermeasures against eavesdropping can be provided in the physical layer in the case of using the optical fiber. Although details will be described below, more specifically, pieces of unit information (for example, bit strings of a predetermined length) can be transmitted using a nature of shot noise in an optical signal such that signals indicating the pieces of unit information cannot be mutually identified. Here, from the viewpoint of the security countermeasures, it is desired to improve not only the nature of shot noise in an optical signal as described above but also the security by various elements accompanied with the shot noise. Furthermore, in a case where it is sufficient to achieve a certain level of security, it is desired to adopt, as a configuration for achieving the certain level of security, elements such that the cost required for such achievement can be reduced. Thus, it is desired to improve the security and improve the convenience such as cost reduction in the countermeasures against eavesdropping in the physical layer.

An object of the present invention is to improve convenience in countermeasures against eavesdropping in a physical layer.

### Means for Solving the Problems

To achieve the above object, a signal processing system according to an aspect of the present invention includes: a transmission unit that modulates laser light to transmit, as a first optical signal, the laser light at a first intensity so that N values of transmission information (where N is an integer value of 2 or more) corresponds to M symbol points (where M is an integer value greater than N) in accordance with a predetermined protocol to detect the laser light at a same position as an optical signal associated with an optical signal associated with another proximate symbol point on an IQ plane when an optical signal associated with a predetermined symbol point among the M symbol points is received, and so that the transmission information is detected as an optical signal associated with another symbol point on the IQ plane when an optical signal associated with a predetermined symbol point is received;
a reception unit that receives a first optical signal and a second optical signal via a path;
an acquisition unit that acquires, as a third optical signal, a laser modulated in accordance with the predetermined protocol for demodulation; and
a demodulation unit that demodulates transmission information using a scheme of causing the second optical signal and the third optical signal to interfere with each other to perform the demodulation,
wherein it is sufficient if the first intensity is less than two times the second intensity that is a lower limit at which the second optical signal is able to be demodulated.

### Effects of the Invention

By virtue of the present invention, it is possible to improve convenience in countermeasures against eavesdropping in a physical layer.

### BRIEF DESCRIPTION OF THE DRAWINGS

FIG. 1 is a block diagram showing an example of a configuration of a signal transmission/reception system including a signal transmission system according to an embodiment of a signal processing system of the present invention;

FIG. 2A is a view for describing an overview of the principle of Y-00 optical communication quantum cryptography applied to the signal transmission system of FIG. 1;

FIG. 2B is a view for describing an overview of the principle of Y-00 optical communication quantum cryptography applied to the signal transmission system of FIG. 1;

FIG. 2C is a view for describing an overview of the principle of Y-00 optical communication quantum cryptography applied to the signal transmission system of FIG. 1;

FIG. 3 is an enlarged view of FIG. 2 in order to enable visual recognition of the arrangement of three adjacent symbol points among the arrangement of N=4096 symbol points in the phase modulation in FIG. 2;

FIG. 4A is a view showing an example of a phase modulation method in a cryptographic signal decryption unit of an optical reception device of FIG. 1;

FIG. 4B is a view showing an example of a phase modulation method in the cryptographic signal decryption unit of the optical reception device of FIG. 1;

FIG. 5 is a view showing an example of adjustment of output power of an optical transmission device in a case where decryption in an optical domain shown in FIG. 4 is employed;

FIG. 6 is a view showing an example of a configuration for performing homodyne detection in the decryption in the optical domain;

FIG. 7 is a view showing an example of a more preferable configuration for performing homodyne detection in the decryption in the optical domain;

FIG. 8 is a view showing an example of a flow of modulation for decrypting an optical signal (cryptographic signal) of quadrature phase amplitude modulation;

FIG. 9 is a view showing an example of a configuration for performing homodyne detection in the decryption of the optical signal of quadrature amplitude modulation in the optical domain;

FIG. 10 is a view showing an example different from FIG. 9 among the examples of a configuration for performing the homodyne detection in the decryption of the optical signal of the quadrature amplitude modulation in the optical domain;

FIG. 11 is a view showing a relationship between the quantum noise masking number and the PSK order after encryption;

FIG. 12A is a view for comparing examples of configurations required for the decryption in the optical domain and the decryption in the electric domain;

FIG. 12B is a view for comparing examples of configurations required for the decryption in the optical domain and the decryption in the electric domain;

FIG. 13 is a view showing an example of a man-in-the-middle attack by an eavesdropper; and

FIG. 14 is a view showing an example of the man-in-the-middle attack by the eavesdropper, the example being different from FIG. 13.

### PREFERRED MODE FOR CARRYING OUT THE INVENTION

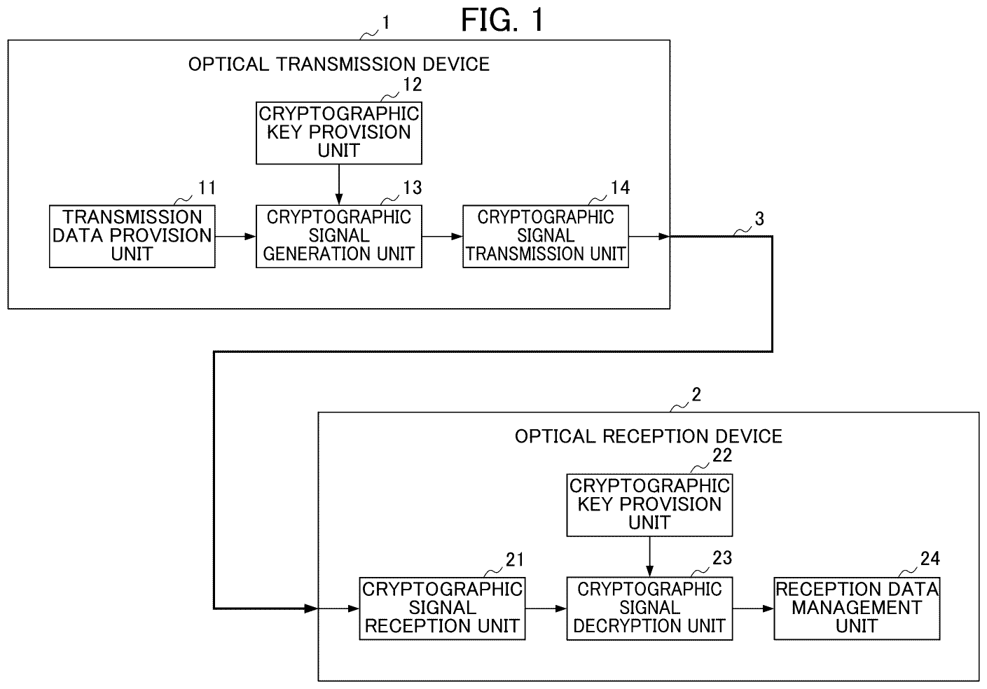

An embodiment of the present invention will be described below. FIG. 1 is a block diagram showing an example of a configuration of an embodiment of a signal processing system of the present invention. The signal processing system in the example of FIG. 1 includes an optical transmission device 1, an optical reception device 2, and a transmission path 3 for connecting these devices.

A transmission data provision unit 11 generates plaintext data to be transmitted or acquires plaintext data from a generation source (not shown), and provides the plaintext data to a cryptographic signal generation unit 13 as transmission data. The cryptographic key provision unit 12 provides the cryptographic signal generation unit 13 with a cryptographic key to use in encryption at the cryptographic signal generation unit 13. It is sufficient if the cryptographic key is a key that can be used in encryption and decryption by the optical transmission device 1 and the optical reception device 2, and there is no limitation in particular on the source of provision of the cryptographic key (place where the cryptographic key is generated or place where the cryptographic key is stored), a method of providing the cryptographic key, and methods of encryption and decryption. The cryptographic signal generation unit 13 encrypts the transmission data provided from the transmission data provision unit 11 using the cryptographic key provided from the cryptographic key provision unit 12, and provides the encrypted transmission data to a cryptographic signal transmission unit 14 which will be described below. The optical signal generated from the cryptographic signal generation unit 13, that is, the optical signal superimposed with the encrypted transmission data is hereinafter referred to as a “cryptographic signal”. The cryptographic signal transmission unit 14 transmits the cryptographic signal generated from the cryptographic signal generation unit 13 to the optical reception device 2 via the transmission path 3 after amplifying the cryptographic signal as necessary.

As described above, the cryptographic signal (optical signal) is output from the optical transmission device 1, transferred through the transmission path 3, and received by the optical reception device 2. The optical reception device 2 decrypts the received cryptographic signal, thereby causing the plaintext data (transmission data) to be restored. For this reason, the optical reception device 2 includes a cryptographic signal reception unit 21, a cryptographic key provision unit 22, a cryptographic signal decryption unit 23, and a reception data management unit 24.

The cryptographic signal reception unit 21 receives the cryptographic signal (optical signal), and provides the signal to the cryptographic signal decryption unit 23. The cryptographic key provision unit 22 provides the cryptographic signal decryption unit 23 with a cryptographic key that is used at the time of decrypting cryptographic signal. The cryptographic signal decryption unit 23 uses the cryptographic key provided from the cryptographic key provision unit 22 to decrypt the cryptographic signal provided from the cryptographic signal reception unit 21, and thus restores the plaintext data (transmission data). The reception data management unit 24 manages the decrypted plaintext data. The plaintext data managed by the reception data management unit 24 is provided to, for example, an information processing device (not shown).

In the present embodiment, a description is given on the assumption that optical fiber communication, which is representative of wired communication, is employed as the transmission path 3. Here, in optical fiber communication, it is theoretically possible for a third party (eavesdropper) to steal large amounts of information (here, cryptographic signal) at once by introducing a branch or the like into an optical fiber and extracting some or all of the signal power. Therefore, even when the cryptographic signal is stolen, there is a need for a method that the meaning and content of the cryptographic signal, that is, the content of the plaintext (transmission data) cannot be recognized by an eavesdropper. As such as method, the applicant has developed a technique using the Y-00 optical communication quantum cryptography.

The Y-00 optical communication quantum cryptography is characterized by “a ciphertext cannot be acquired correctly due to the effect of quantum noise”, and has been developed by the applicant. In the Y-00 optical communication quantum cryptography, transmission data (plaintext) is represented by one or more aggregates of bit data of “0” or “1”. Each bit data that makes up the transmission data is modulated by a predetermined algorithm to a predetermined value among M (M being an integer value of 2 or more) values. Therefore, the numerical value M is hereinafter referred to as “modulation number M”.

In the Y-00 optical communication quantum cryptography, encryption of transmission data (plaintext) is performed by modulating at least one of the phase and amplitude of an optical signal (carrier wave) or a combination thereof by one of the modulation number M of levels, in accordance with a cryptographic key present on the encrypting side and the decrypting side. By making the modulation number M a very large number, the feature of “not allowing an eavesdropper to correctly obtain ciphertext due to effects of quantum noise” is realized.

Furthermore, there may exist the possibility that the cryptography implemented at layer 2 and above in the OSI reference model relying on the mathematical ciphers described above will be decrypted with the advancement of supercomputers, quantum computers, and the like. However, since the quantum noise is an invariant physical phenomenon, the encryption in the physical layer by using the quantum noise has such a characteristic that the future development of the technique does not cause a failure in the security.

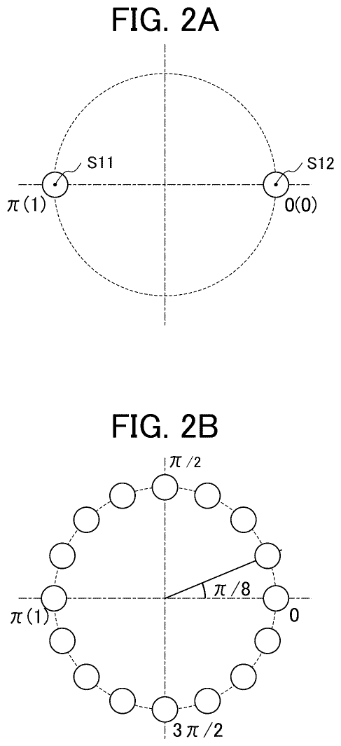

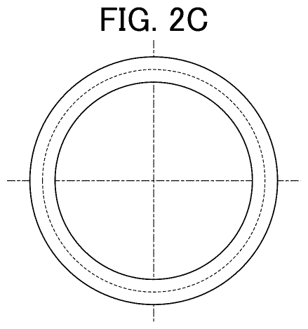

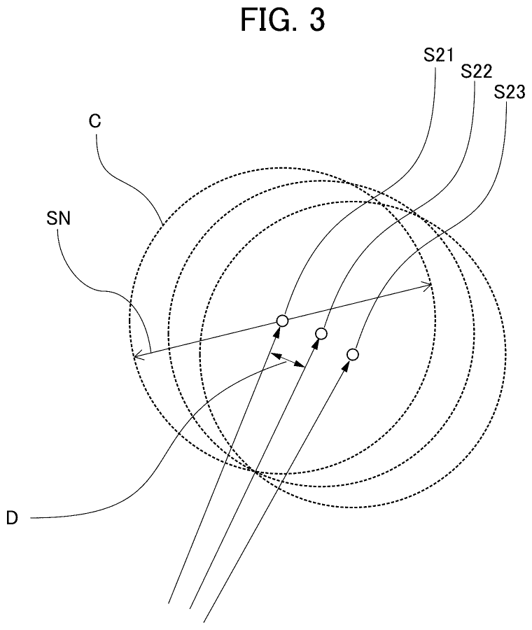

A description will be given below on the premise of the Y-00 optical communication quantum cryptography as a “predetermined protocol” for achieving “not allowing an eavesdropper to correctly obtain ciphertext due to effects of quantum noise”. Regarding the details of the Y-00 optical communication quantum cryptography, please refer to Japanese Unexamined Patent Application, Publication No. 2012-085028. With reference to FIG. 2 and FIG. 3, a simple description is given regarding an overview of the principle of the Y-00 optical communication quantum cryptography, using an example in which phase modulation is employed as a modulation scheme.

FIGS. 2A to 2C show views for describing an overview of the principle of the Y-00 optical communication quantum cryptography applied to the signal processing system of FIG. 1. FIG. 3 is an enlarged view shown in FIG. 2 in order to enable visual recognition of the arrangement of three adjacent symbol points among the arrangement of M=4096 symbol points in the phase modulation shown in FIG. 2. FIGS. 2A to 2C show an IQ plane that represents the phase and amplitude (intensity) of an optical signal, with the intersection of the vertical axis and the horizontal axis as the origin. When a point on one of these IQ planes is determined, the phase and amplitude of the optical signal are uniquely determined. Taking the origin of the IQ plane as the start point, the phase is the angle formed between the line segment having an endpoint at the point representing the optical signal and the line segment representing phase 0. In contrast, the amplitude is the distance between the point representing the optical signal and the origin of the IQ plane.

FIG. 2A is the view for describing the principle of normal binary modulation to facilitate understanding of the Y-00 optical communication quantum cryptography. For example, in a case where the plaintext (transmission data) is superimposed as is on an optical signal (carrier wave) and transmitted, binary modulation indicated shown in FIG. 2A will be performed on each item of bit data (1 or 0) that makes up the plaintext. In this case, in FIG. 2A, the arrangement of a point (hereinafter, referred to as a “symbol point”) indicating the optical signal after phase modulation when the bit data is “0” is the arrangement of a symbol point S12 given by 0(0) on the right side on the horizontal axis, in other words an arrangement where the phase is 0. In contrast, the arrangement of a symbol point after phase modulation when the bit data is 1 is the arrangement of a symbol point S11 given by π(1) on the left side on the horizontal axis, in other words an arrangement when the phase is π. Here, the solid-line circle surrounding the symbol point S11 shows an example of the fluctuation range of the quantum noise when the optical signal of the symbol point S11 is received. For a symbol point S12, similarly, an example of fluctuation range of the quantum noise is shown as a solid-line circle surrounding the symbol point S12.

FIG. 2B is the view for describing the principle of phase modulation when the modulation number M=16, in a case where the Y-00 optical communication quantum cryptography is employed. In the case of the example of FIG. 2B, a random level from among eight levels is generated by using the cryptographic key, for each item of bit data that makes up the plaintext. The phase modulation is performed by, for each bit, rotating the phase of the symbol point in the normal binary modulation indicated in FIG. 2A (the point for phase 0 corresponding to 0 and the point for phase I corresponding to 1) in the IQ plane in accordance with the level from among the eight levels that is generated randomly by using the cryptographic key. Because the value that bit data can take is binary-either “0” or “1”, as a result, when the phase modulation of the example of FIG. 2B is performed, the arrangement of the symbol points becomes an arrangement of 16 points (modulations number M=16) for which the respective phases differ by π/8.

However, in the case of the example of FIG. 2B, the value—“0” or “1”—that the bit data can take is merely modulated to one of the levels from among the modulation number M=16 levels. Therefore, if the optical signal (cryptographic signal), which has the arrangement of 16 symbol points, is intercepted, there is the risk that the meaning of its content—in other words the content of the plaintext (transmission data)—will be recognized (decrypted) by an eavesdropper. In other words, the security of the Y-00 optical communication quantum cryptography is not sufficient at only around the modulation number M=16. Accordingly, in practice, as shown in FIG. 2C, a very large number, for example 4096, is employed as the modulation number M, and the security of the Y-00 optical communication quantum cryptography is improved.

FIG. 2C is the view for describing the principle of phase modulation when the modulation number M=4096, in a case where the Y-00 optical communication quantum cryptography is employed. FIG. 3 is an enlarged view of FIG. 2C in order to enable visual recognition of the arrangement of three adjacent symbol points among the arrangement of M=4096 symbol points in the phase modulation of in FIG. 2C. As shown in FIG. 3, for each symbol point from S21 to S23, there is fluctuation due to shot noise (quantum noise) in only a range SN. Specifically, for example, the solid-line circle C surrounding the symbol point S21 shown in FIG. 3 shows an example of the fluctuation range SN of the quantum noise when the optical signal of the symbol point S21 is received.

Here, the shot noise is noise due to the quantum nature of light, is truly random, and has a characteristic of being one of the laws of physics that is not set aside. As a result, when phase modulation with a very large number, such as 4096, as the modulation number M, is performed, adjacent symbol points cannot be discriminated from one another because they are obscured by shot noise, as shown in FIG. 3. In other words, when the distance D between two adjacent symbol points S21 and S22 is sufficiently smaller than the range SN of shot noise (when the phase modulation with a very large number as the modulation number M is performed so as to make the distance D thus small), it is difficult to determine the position of the original symbol point from phase information measured at a receiving side.

Specifically, for example, a case is considered where the phase measured on the receiving side at a certain time corresponds to the position of the symbol point S22 shown in FIG. 3. In such a case, there is the possibility that the measured phase is transmitted as an optical signal for a symbol point S22 and the shot noise is extremely small. Alternatively, there is the possibility that the measured phase is transmitted as an optical signal for a symbol point S21 and is measured as the phase corresponding to the position of the symbol point S22 due to the effect of shot noise. Similarly, there is the possibility that the measured phase is transmitted as an optical signal for a symbol point S23 and is measured as the phase corresponding to the position of the symbol point S22 due to the effect of shot noise. An eavesdropper cannot distinguish which of these possibilities is correct. To summarize the above, modulation where the modulation number M is very large, in other words, the modulation with a very large number is employed in the Y-00 optical communication quantum cryptography.

Although the modulation is phase modulation in the example of FIGS. 2 and 3, the modulation may be amplitude (intensity) modulation instead of or in addition to phase modulation. In other words, optical signal modulation using the Y-00 protocol can employ any modulation scheme such as intensity modulation, amplitude modulation, phase modulation, frequency modulation, and quadrature amplitude modulation. In other words, as described above, with the Y-00 optical communication quantum cryptography, it becomes possible to make the distance D between two symbol points sufficiently smaller than the range SN of shot noise in any modulation scheme, and the feature of “not allowing an eavesdropper to correctly obtain ciphertext due to effects of quantum noise” becomes possible. In addition, although details will be described below, quantum noise ensures security, but in practice an eavesdropper is prevented from obtaining the correct ciphertext due to the effect of all “noise”, including classical noise such as thermal noise in addition to quantum noise.

Next, the security of the Y-00 optical communication quantum cryptography will be described below using the masking number Γ_{Q} which is an index of security. In other words, as the index of security in the Y-00 optical quantum cryptography, the masking number Γ_{Q} corresponding to “how many adjacent symbols are masked by shot noise” can be employed.

In optical communication, when an optical signal having an intensity sufficient for high-speed communication is employed, the distribution of the amount of shot noise (fluctuation range) can be approximated as a Gaussian distribution. Therefore, for the masking number Γ_{Q} in this example, the distance (radius) corresponding to the range SN of the shot noise described above with reference to FIG. 3 employs the standard deviation of the Gaussian distribution of shot noise. In other words, a description will be given below with respect to a case where “the number of symbol points falling within the range of the standard deviation when the noise distribution is approximated as a Gaussian distribution” is defined as the masking number Γ_{Q}. The concept of the masking number Γ_{Q} is applicable to other than the shot noise distribution. A method of applying the concept of the masking number Γ_{Q} to other noises will be described below.

As described above with reference to FIG. 2, when the distance D between two adjacent symbol points is sufficiently smaller than the range SN of the shot noise, it is difficult to determine the position of the original symbol point from the information measured on the receiving side. In other words, the masking number Γ_{Q} is the number of other symbol points included in the range SN of shot noise. In other words, the masking number Γ_{Q} indicates the number of other symbol points of which distance D from a certain symbol point is smaller than the range SN of shot noise. In other words, the masking number Γ_{Q} is proportional to cipher intensity of the cryptographic signal.

For example, when the phase modulation scheme is employed in the Y-00 optical quantum cryptography, the masking number Γ_{Q} is represented by Formula (1) below.

$${Γ}_{Q} = \frac{N \cdot {2}^{m}}{2 π} \sqrt{\frac{2 {hv}_{0} B}{{η}_{q} {P}_{0}}} \qquad ( 1 )$$

Here, in Formula (1), N represents the number of data modulation signals (the number of values of the transmission information transmitted per one symbol). An encryption bit number m is a number obtained by representing the number of levels increased per data modulation signal for encryption with bits. Planck's constant h is a physical constant and is a constant of proportionality related to the energy and frequency of photons. The frequency v0 is a frequency of the signal. The reception band B is a reception band in the detection of the receiver. The quantum efficiency η_{q} is a quantum efficiency of the receiver. The power P0 is the number representing the signal power.

Here, the data modulation signal number N and the encryption bit number m will be described in association with the description of FIG. 2. The data modulation signal number N=2 corresponds to the number of symbol points S11 and S12 in the description of FIG. 2A. An increase in the number of levels of the encryption bit number m=11 means that the number of symbol points is increased from one to 2 to the power of 11 (=2048). In other words, the number of levels of each of the two symbol points S11 and S12 in the description of FIG. 2C is increased to 2 to the power of 11 (=2048), which corresponds to the transmission as the symbol points of the modulation number M=4096.

When the masking number Γ_{Q} is a sufficiently large value, masking by shot noise works. In other words, the Y-00 optical quantum cryptography works effectively as a cryptography. Specifically, for example, when such a value is one or more which is enough large value to exhibit the effect of masking due to the shot noise, higher security is achieved. Here, referring to Formula (1), the masking number Γ_{Q} is inversely proportional to the square root of the power P0. In other words, in a case where the power P0 of the carrier wave is small, the masking number Γ_{Q} is large and the security in encryption is high. In other words, it can be said that increasing the number of levels of the signal and lowering the signal power within a range not affecting the communication quality leads to the improvement in security. Although details will be described below, the present invention can achieve improvement in the security and improvement in the convenience such as cost reduction in the countermeasures against eavesdropping in the physical layer, focusing on the power P0 that affects the masking number Γ_{Q}.

Here, as described above, the noise in the optical signal fluctuates depending on characteristics of a transmission path for the optical signal and its surrounding environments. In other words, masking by noise may include not only the masking number Γ_{Q} described above but also all kinds of noise including the noise in the optical signal fluctuating depending on characteristic of the transmission path for the optical signal and its surrounding environments and the classical noise such as thermal noise. In other words, when the masking number by the classical noise other than the masking number Γ_{Q} related to the shot noise described in Formula (1) described above is defined as Γ_{C}, the masking number becomes as Γ_{Q}+Γ_{C}. Specifically, for example, there may be employed the number of symbol points included in the range of the fluctuation of the signal in the generation of the optical signal (cryptographic signal) and the classical noise such as thermal noise depending on its surrounding environments in addition to the noise due to the shot noise described above.

To summarize the above, if the distance between two adjacent symbol points is sufficiently smaller than the range of all kinds of noise including the classical noise such as thermal noise, the confidentiality of the signal using masking can be achieved. Here, when the optical signal transmitted from the optical transmission device 1 is received, if the masking number Γ_{Q} related to the shot noise is one or more, the feature of “not allowing an eavesdropper to correctly obtain ciphertext due to effects of quantum noise” can be achieved. The possibility is left that an eavesdropper reduces the masking number Γ_{C} related to the classical noise by some means, but it is impossible in principle to reduce the masking number δ_{Q} related to the shot noise, which plays an important role to ensure the lower limit of the security.

Next, the present invention is achieved by utilizing a difference in conditions at the time of decryption between a legitimate receiver (an installer of the reception device 2 of FIG. 1) and an eavesdropper (a person who extracts some or all of the signal power from the transmission path 3 of FIG. 1 to attempt decrypting the cipher) in the decryption of the optical signal (cryptographic signal).

In other words, as described above, the encryption is achieved by converting a signal phase-modulated to the modulation number M=2 shown in FIG. 2A into a signal phase-modulated to the modulation number M=4096 shown in FIG. 2C, in the optical transmission device 1. On the other hand, the decryption is achieved by converting a signal phase-modulated to the modulation number M=4096 shown in FIG. 2C into a signal phase-modulated with the modulation number M=2 shown in FIG. 2A, in the optical reception device 2. More specifically, on the premise of a phase modulation amount (magnitude and direction) used for each symbol at each time when the modulation number M is increased from 2 to 4096 in the optical transmission device 1, the modulation is performed in a direction opposite to the phase modulation amount in the optical reception device 2, whereby the optical signal (cryptographic signal) is decrypted. Thus, the modulation for the decryption can be implemented as follows.

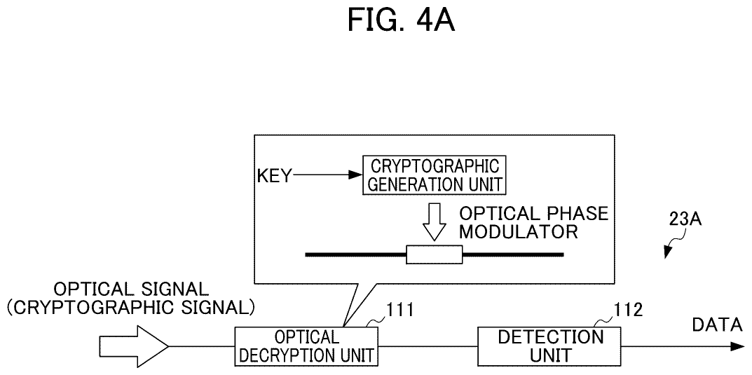

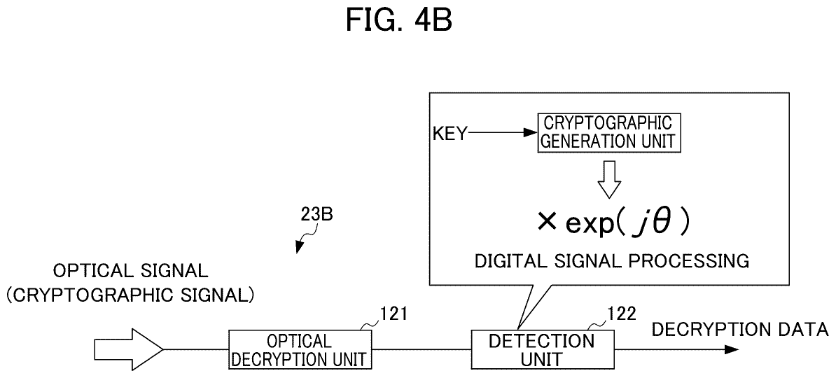

FIGS. 4A and 4B each are a view showing an example of a phase modulation method in a cryptographic signal decryption unit of the optical reception device of FIG. 1. FIG. 4A shows a cryptographic signal decryption unit 23A in which the scheme of performing decryption in the optical domain is employed, in the cryptographic signal decryption unit 23 of the optical reception device 2 of FIG. 1. FIG. 4B shows a cryptographic signal decryption unit 23B in which the scheme of performing decryption in the electric domain is employed, in the cryptographic signal decryption unit 23 of the optical reception device 2 of FIG. 1.

First, the cryptographic signal decryption unit 23A in which the scheme of performing decryption in the optical domain is employed will be described as shown in FIG. 4A. The decryption in the optical domain means that an optical signal (cryptographic signal) decrypted by subjecting the optical signal to the phase modulation is detected (received), thereby obtaining the decrypted data. In other words, the cryptographic signal decryption unit 23A in which the scheme of performing decryption in the optical domain is employed includes an optical decryption unit 111 and a detection unit 112. The optical decryption unit 111 includes a cryptographic generation unit that uses the key provided from the cryptographic key provision unit 22 to generate a cipher, and an optical phase modulator that performs modulation based on the cipher generated by the cryptographic generation unit.

Here, the cryptographic generation unit will be described. Although not shown, the cryptographic generation unit also includes the cryptographic signal generation unit 13 of the optical transmission device 1. In addition, the “cipher” generated by the cryptographic generation unit corresponds to the phase modulation amount (magnitude and direction) used for each symbol at each time based on the cryptographic key by a predetermined protocol. In other words, in the cryptographic signal generation unit 13 of the optical transmission device 1, an optical signal (cryptographic signal) is generated by performing the phase modulation based on the cipher generated by the cryptographic generation unit. On the other hand, in the cryptographic signal decryption unit 23 (here, the cryptographic signal decryption unit 23A) of the optical reception device 2, an optical signal (cryptographic signal) is generated by performing the phase modulation based on the cipher generated by the cryptographic generation unit, contrary to the optical transmission device 1.

Thus, in the optical decryption unit 111 of the cryptographic signal decryption unit 23A, the decryption in the optical domain is performed by the optical phase modulator based on the cipher generated by the cryptographic generation unit. The detection unit 112 detects the decrypted optical signal, thereby outputting the decrypted digital data.

In the case where the phase modulation, in particular, BPSK is used as described above, the homodyne scheme is employed in the detection unit 112. In addition, in the case where the IQ data modulation of QPSK or more is used, the scheme such as heterodyne detection, phase-diversity homodyne detection, or phase-diversity intradyne detection is employed.

Next, the cryptographic signal decryption unit 23B in which the scheme of performing decryption in the electric domain is employed will be described as shown in FIG. 4B. The decryption in the electric domain means that an optical signal (cryptographic signal) is detected (received) and the decryption is performed by subjecting the detected and digitized information to phase modulation by digital signal processing, thereby obtaining the decrypted data. In other words, the cryptographic signal decryption unit 23B in which the scheme of performing decryption in the electric domain is employed includes a detection unit 121 and an electric decryption unit 122.

The detection unit 121 detects an optical signal (cryptographic signal) and converts the position on the IQ plane of the optical signal (cryptographic signal) as is into the digital data.

The electric decryption unit 122 includes a cryptographic generation unit that uses the key provided from the cryptographic key provision unit 22 to generate a cipher, and a digital signal processing circuit that performs modulation based on the cipher generated by the cryptographic generation unit. The function of the cryptographic generation unit is similar to the description in the optical decryption unit 111 described above.

The “Xexp (jθ)” in FIG. 4B indicates that an operation is performed in which the optical signal (cryptographic signal) stored as the digital data which is a detection result of the optical signal (cryptographic signal) is rotated by a phase of angle θ with respect to the position on the IQ plane. In other words, in the electric decryption unit 122 of the cryptographic signal decryption unit 23B, the position on the IQ plane of the optical signal (cryptographic signal) which is a detection result of the optical signal (cryptographic signal) is phase-converted by the digital signal processing, so that the decryption in the electric domain (digital electric signal area) is performed.

Thus, in the case where the detection for decryption is performed in the electric domain, in the detection unit 121, it is necessary to convert the position on the IQ plane of the optical signal (cryptographic signal) as is into the digital data. For this reason, the scheme such as heterodyne detection, phase-diversity homodyne detection, or phase-diversity intradyne detection which can acquire the information about both I and Q is employed in the detection unit 121.

Thus, both approaches of the decryption in the optical domain and the decryption in the electric domain are possible for the decryption of the optical signal (cryptographic signal). However, when the decryption in the optical domain is positively employed and a difference in reception performance between a legitimate receiver and an eavesdropper is used, the security of the cipher can be improved.

In other words, since the eavesdropper does not have a key which the legitimate receiver has, the eavesdropper needs to perform the decryption afterward, after eavesdropping. For this reason, when eavesdropping, the eavesdropper first performs the IQ simultaneous detection represented by the heterodyne detection, and then attempts decryption by the digital signal processing. This is basically the same process as the decryption in the electric domain described above.

On the other hand, since the legitimate receiver has the key, the legitimate receiver does not need to perform decryption afterward. In other words, the decryption can be performed in the optical domain before the detection. For this reason, it becomes possible to use the reception scheme with higher receiving sensitivity than the IQ simultaneous detection represented by the heterodyne detection as the subsequent detection scheme. This is none other than the decryption in the optical domain described above. Specifically, for example, as the most practical method, when the data modulation is BPSK, the legitimate receiver can employ the homodyne detection as the detection unit after the decryption in the optical domain.

In the system dominated by the shot noise, the receiving sensitivity of the homodyne detection is higher by about 3 dB as compared with the receiving sensitivity of the IQ simultaneous detection such as the heterodyne detection. In other words, it can be said that an equivalent error rate is achieved with approximately one half of the received power.

In other words, the cryptographic decryption unit 23A in which the decryption in the optical domain and the homodyne detection are employed as shown in FIG. 4A and the cryptographic decryption unit 23B in which the heterodyne detection and the decryption in the electric domain are employed as shown in FIG. 4B are considered. In this case, in the cryptographic decryption unit 23A in which the homodyne detection is employed, the received power required to achieve the same error rate on the receiving side is smaller by about 3 dB.

In other words, a case is considered where the optical signal (cryptographic signal) is transmitted so that the error rate for the legitimate receiver is not changed. In this case, in the cryptographic decryption unit 23A, the signal power required on the receiving side is halved as compared with the cryptographic decryption unit 23B, and thus the power output on the transmitting side can be also halved.

Here, as shown in Formula (1) described above, it is understood that when the signal power P0 becomes ½ times, the masking number becomes the square root of 2 times. In other words, the effect is obtained that when the legitimate receiver performs the decryption in the optical domain and the homodyne detection, the masking number for the eavesdropper becomes that times the square root of 2.

Thus, since the legitimate receiver holds the key in advance, as a configuration of the optical reception device 2, the decryption in the optical domain can be employed, and the homodyne detection or the like with higher receiving sensitivity as compared with the IQ simultaneous detection (heterodyne detection or the like) can be further employed. This makes it possible to reduce the signal power on the transmitting side and improve the security of the cipher.

Accordingly, unless otherwise noted, a description will be given below on the assumption that in the cryptographic signal decryption unit 23 of the optical reception device 2, the decryption in the optical domain is employed, and the detection unit in which the homodyne detection or the like with high receiving sensitivity is employed is provided.

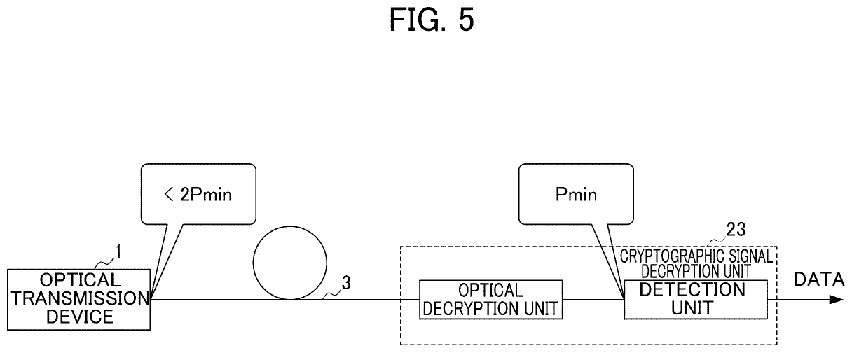

Furthermore, with reference to FIG. 5, a description is given by the fact that the decryption in the optical domain is performed by the homodyne detection, making it possible to achieve further high security of different property. FIG. 5 is a view showing an example of adjustment of output power of the optical transmission device in a case where decryption in the optical domain shown in FIG. 4 is employed.

In the example of FIG. 5, only the cryptographic signal decryption unit 23 of the optical reception device 2 in the signal processing system of FIG. 1 is shown. Here, as the signal power input to the detection unit, a signal power Pmin is employed. The signal power Pmin is a minimum signal power required for the demodulation using the homodyne detection. As the signal power output from the optical transmission device 1, less than a signal power 2Pmin is employed.

This makes it possible to obtain the following effect. In other words, the extremely high security against the eavesdropping (the security equivalent to or exceeding the information-theoretic security) can be achieved.

Here, the information-theoretic security means that since decryption results obtained by all keys have similar likelihood, it is impossible to perform the decryption even with any computing power. The term of the information-theoretic security is normally used as the term in encryption by mathematical bit operation, and is not used as the term normally used for the cipher protecting the signal by physical properties of the optical signal as in this present optical signal processing system. When the coding appropriate for this cipher is combined, it can be expected to achieve the information-theoretic security. Furthermore, as described below, it is possible to achieve such excellent features that the security is ensured even when the key is made public afterward, the features being essentially different from the information-theoretic security.

As described above, the eavesdropper extracts some or all of the signal power from the transmission path 3 to eavesdrop the optical signal (cryptographic signal). As described above, since the eavesdropper attempts the decryption in the electric domain, it is necessary to perform the IQ simultaneous detection (heterodyne detection or the like). As described above, the IQ simultaneous detection (heterodyne detection or the like) has such a property that the receiving sensitivity is lower by about 3 dB (½ times) as compared with the homodyne detection. In other words, to correctly detect the IQ simultaneous detection (heterodyne detection or the like), the signal power higher by 3 dB (2 times) as compared with the homodyne detection is required. However, in the transmission path 3, even when the eavesdropper extracts all of signal power, the signal power is less than 2Pmin. In other words, the signal power extracted by the eavesdropper is provided with the minimum receiving sensitivity or less of the IQ simultaneous detection (heterodyne detection or the like).

This makes it possible to achieve the extremely high security against the eavesdropping (the security equivalent to or exceeding the information-theoretic security). As a result, it is assumed that the eavesdropper obtains the key afterward after the IQ simultaneous detection (heterodyne detection or the like). In this case, the eavesdropper attempts the decryption by the digital signal processing using the correct key, but even when any digital signal processing is performed on the position on the IQ plane of the optical signal (cryptographic signal) detected with the minimum receiving sensitivity or less, it is impossible to decrypt the correct data. This is a characteristic not relaying on the conventional mathematical ciphers such as AES. Also in the one-time-pad encryption (a cipher with one-time key used for each bit) that can achieve the information-theoretic security, it is an advantageous feature that enables the achievement with this cipher without assuming a situation where the key is obtained afterward (the key could not be revoked correctly).

Here, the conditions to be satisfied in a case where the decryption in the optical domain is actually performed will be summarized. First, there is a condition that the optical transmission loss in the transmission path 3 and the like is reduced to 3 dB or less. This condition is normally satisfied in the case where the transmission path 3 is sufficiently short. The study for achieving the transmission path 3 with small signal loss has been conventionally performed and it is expected to further improve the performance.

There is also a condition that an optical amplifier is not used for the signal processing system. Similarly to the condition described above, it is not necessary to use the optical amplifier in the case where the transmission path 3 is sufficiently short, and thus the condition is satisfied.

Next, there is a condition that the influence of chromatic dispersion is suppressed such that the decryption in the optical domain can be performed. Here, the chromatic dispersion means a dispersion in which the transmission speeds of signals in the transmission path 3 are different depending on different wavelengths. In other words, when the optical signals in a certain wavelength occupied band are transmitted, a difference in arrival time among the optical signals occurs in the transmission path 3 and the like due to the chromatic dispersion. This causes distortions in the time waveforms of the optical signals. As described above, when the decryption in the optical domain is performed, the phase modulation is performed by the optical phase modulator or the like. A case is considered where the optical signals (cryptographic signals) are transmitted from the optical transmission device 1, and under the influence of chromatic dispersion in the transmission path 3, are decrypted as is in the optical domain in the optical reception device 2. In this case, some of the optical signals in which distortions are caused in the time waveforms are present across adjacent time slots, and the correct phase modulation for decryption is not performed on some of the signals. Accordingly, it is necessary to suppress the influence of chromatic dispersion such that the decryption in the optical domain can be performed.

The chromatic dispersion is a linear phenomenon. Accordingly, the compensation can be performed by applying filtering of the reverse characteristic on a side of the optical transmission device 1 according to the characteristics of chromatic dispersion of the transmission path 3. Specifically, for example, in the optical transmission device 1, it can be solved by performing, in addition to the phase modulation for encryption, the optical modulation with electric signals that electrically apply filtering according to the characteristics of chromatic dispersion of the transmission path 3. For example, it can be solved by returning the chromatic dispersion that occurred using the dispersion compensator such as a dispersion compensation fiber.

It is necessary to sufficiently reduce the signal power loss in the decryption in the optical domain. In other words, for example, it is necessary to set the sum of the optical transmission loss in the transmission path 3 and the like and the signal power loss in the decryption in the optical domain to less than 3 dB.

A description will be given below regarding a method of sufficiently reducing the signal power loss in the decryption in the optical domain.

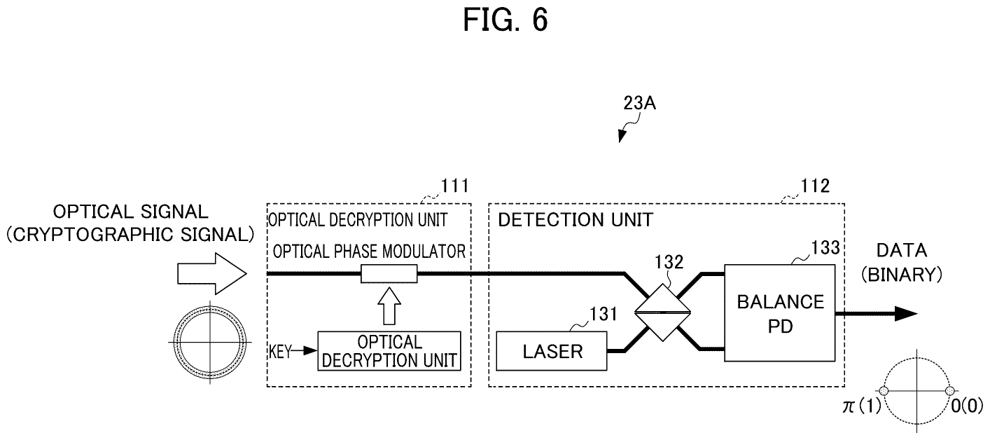

FIG. 6 is a view showing an example of a configuration for performing the homodyne detection in the decryption in the optical domain. FIG. 6 shows an example of a specific configuration of the optical decryption unit 111 that performs the decryption in the optical domain and the detection unit 112 that performs the homodyne detection, the optical decryption unit 111 and the detection unit 112 being included in the cryptographic signal decryption unit 23A of FIG. 4A. The optical decryption unit 111 of FIG. 6 includes the cryptographic generation unit and the optical phase modulator as described above in the description of FIG. 4A. In other words, the cryptographic signal decryption unit 23A of FIG. 6 performs the phase modulation with respect to the optical signal (cryptographic signal) in the optical decryption unit 111.

The detection unit 112 of FIG. 6 includes a laser 131, a beam splitter 132, and a balance PD (Photo Diode) 133 as a configuration for performing the homodyne detection. In other words, the laser 131 of FIG. 6 generates local light having a frequency for the homodyne detection. The beam splitter 132 causes the optical signal (the decrypted signal) that has been subjected to the phase modulation in the optical decryption unit 111 to interfere with the local light generated by the laser 131. The balance PD 133 outputs binary data based on the difference between the two optical signals subjected to the interference by the beam splitter 132.

This enables the achievement of the decryption in the optical domain, which is described with reference to FIG. 4A and the like. However, the optical decryption unit 111 of FIG. 6 performs the phase modulation with respect to the optical signal (cryptographic signal). In other words, in the phase modulation in the optical phase modulator, an attenuation of the signal to the optical signal is normally caused.

Here, as described above, it is necessary to set the sum of the optical transmission loss in the transmission path 3 and the like and the signal power loss in the decryption in the optical domain to less than 3 dB. Therefore, since the signal power loss occurs in the decryption in the optical domain, there is a disadvantage in that the optical transmission loss permitted in the transmission path 3 is reduced.

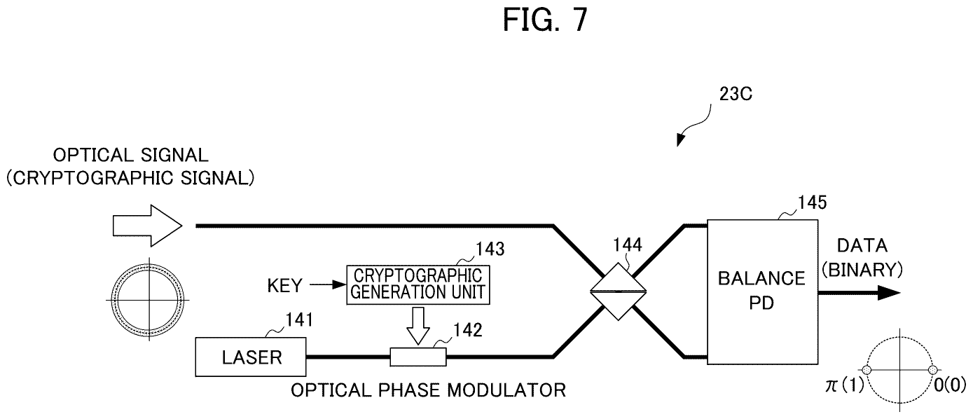

This disadvantage is eliminated by employing a configuration shown in FIG. 7. FIG. 7 is a view showing an example of a more preferable configuration for performing the homodyne detection in the decryption in the optical domain.

FIG. 7 shows an example of a more preferable configuration of a cryptographic signal decryption unit 23C for performing the decryption in the optical domain and the homodyne detection, which is different from the cryptographic signal decryption unit 23 shown in FIGS. 4A and 4B (the cryptographic signal decryption units 23A and 23B in FIG. 4). The cryptographic signal decryption unit 23C of FIG. 7 includes a laser 141, an optical phase modulator 142, a cryptographic generation unit 143, a beam splitter 144, and a balance PD 145.

In other words, the laser 141 of FIG. 7 generates local light having a frequency for the homodyne detection. The optical phase modulator 142 modulates the local light generated by the laser 141 based on the cipher generated by the cryptographic generation unit 143. The function of the cryptographic generation unit 143 is similar to the description in the optical decryption unit 111 of FIG. 4A. The beam splitter 144 causes the optical signal (cryptographic signal) to interfere with the optical signal obtained by modulating the local light by the optical phase modulator 142. The balance PD 145 outputs binary data based on the difference between the two optical signals subjected to the interference by the beam splitter 144.

Here, the output of the homodyne detection is a product of electric fields of the signal light (here, a cryptographic signal) and the local light. For this reason, modulating the phase of the local light generated from the laser 141 can provide the same effect as reversely rotating the phase of the signal light (cryptographic signal).

This enables the achievement of the decryption in the optical domain. The configuration shown in FIG. 7 is more preferable as follows as compared with the configuration shown in FIG. 6. In other words, in the configuration shown in FIG. 7, the phase modulation is not performed on the optical signal (cryptographic signal). In other words, since the optical signal (cryptographic signal) does not pass through the optical phase modulator, a signal attenuation of the optical signal (cryptographic signal) does not occur. Thus, since the signal power loss does not occur in the decryption in the optical domain, there is no disadvantage in that the optical transmission loss permitted in the transmission path 3 is reduced.

In actual operation, it is necessary to set the laser of the local light to have the same frequency as the signal light. It is preferable to employ, in addition to the configuration shown in FIG. 7, a feedback mechanism such as PPL and a mechanism for transmitting carrier light serving as a clock together with the signal light and injecting them into the laser for the local light for synchronization.

Thus, employing the configuration shown in FIG. 7 makes it possible to reduce the signal power loss in the decryption in the optical domain among the conditions to be satisfied in the case where the decryption in the optical domain is actually performed. Furthermore, even in the environment in which the optical transmission loss in the transmission path 3 becomes larger, it is possible to achieve the decryption in the optical domain.

Here, an additional description of a difference between the homodyne detection and the heterodyne detection is given. In FIGS. 6 and 7, the cryptographic signal decryption units 23A and 23C include a laser, a beam splitter and a balance PD as a configuration for the homodyne detection. However, both of the homodyne detection and the heterodyne detection have this configuration. A difference between the homodyne detection and the heterodyne detection is a frequency of the local light generated from the laser.

In other words, in the homodyne detection, the local light and the signal are made to have the same frequency. As a result, in the homodyne detection, only one side of IQ components is acquired as a signal of a band B/2. Then, in the heterodyne detection, a difference between the local light frequency and the signal frequency is set to be larger than a half of the band B. Thus, both of the IQ components are acquired as a signal of the band B (IQ simultaneous detection). Thus, in the homodyne detection, since the band is halved as compared with the heterodyne detection, the influence of the shot noise is halved. Then, since the influence of the shot noise is halved as described above, even when the signal power which is a half of the signal power of the heterodyne detection is employed in the homodyne detection, the same SNR is obtained.

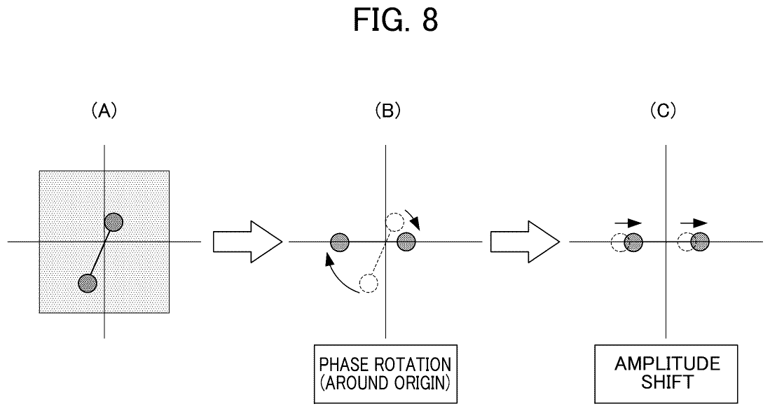

Although the description has been given using the example in which the phase modulation is employed as the modulation scheme of the optical signal (cryptographic signal or the like), an example in which the quadrature amplitude modulation (QAM) is applied is described with reference to FIG. 8. FIG. 8 is a view showing an example of a flow of modulation for decrypting an optical signal (cryptographic signal) of quadrature amplitude modulation.

In the quadrature amplitude modulation, the IQ simultaneous detection is normally performed. However, an increase in the number of levels to enable the homodyne detection after the decryption in the optical domain when the data modulation is BPSK makes it possible to apply a process of the decryption in the optical domain described above to the optical signal (cryptographic signal) in which the quadrature amplitude modulation is employed.

A square shaded area shown in FIG. 8(A) shows a state in which the quadrature amplitude modulation with a very large number is performed, and signals are present throughout the IQ plane. Among them, 1 bit (zero and 1) at a certain time is indicated by two circles and a line segment connecting them. FIG. 8(B) shows the example in which 1 bit at the certain time shown in FIG. 8(A) is phase-rotated about an origin. FIG. 8(C) shows the example in which the amplitude is shifted with respect to the optical signal that is phase-rotated about the origin as shown in FIG. 8(B).

Thus, the position on the IQ plane of the signal shown in FIG. 8(C) is similar to figures such as FIG. 7 shown as the data (binary). In other words, the signal can be subjected to the homodyne detection.

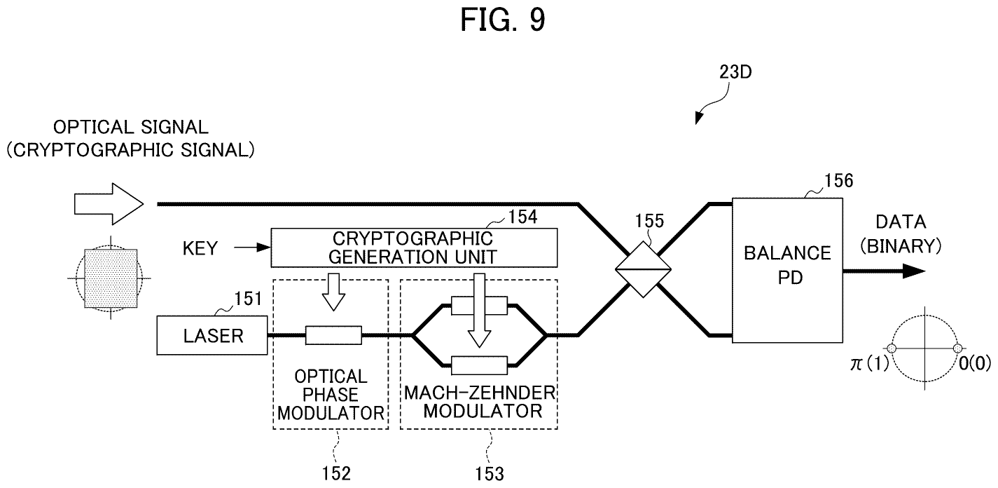

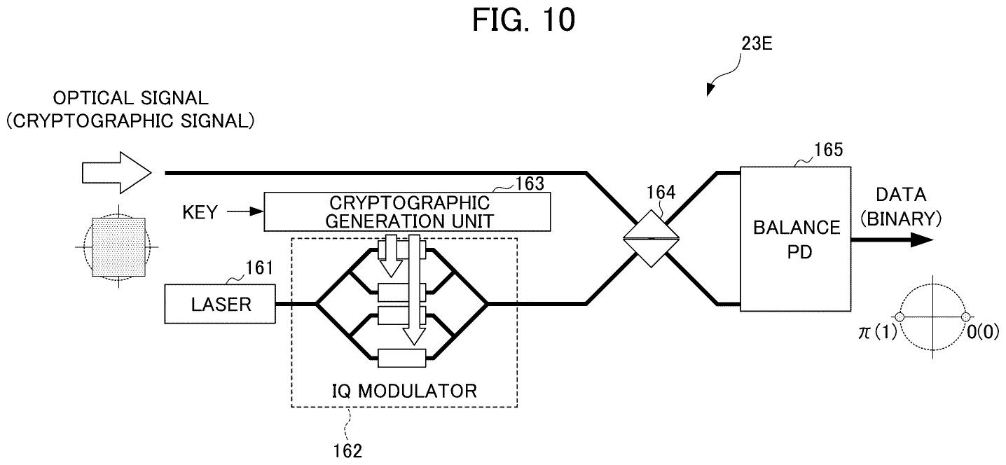

In the description up to FIG. 7, in the decryption in the optical domain, only the phase modulation has been performed using one phase modulation element. However, in the case where the decryption in the optical domain is performed on the optical signal (cryptographic signal) of the quadrature amplitude modulation, it is necessary to use a modulator shown in FIG. 9 or 10 because the decryption cannot be achieved using one phase modulation element. FIG. 9 is a view showing an example of a configuration for performing the homodyne detection in the decryption of the optical signal of the quadrature amplitude modulation in the optical domain. A cryptographic signal decryption unit 23D of FIG. 9 includes a laser 151, an optical phase modulator 152, a Mach-Zehnder modulator 153, a cryptographic generation unit 154, a beam splitter 155, and a balance PD 156.

In other words, the function of each of the laser 151, the cryptographic generation unit 154, the beam splitter 155, and the balance PD 156 of FIG. 9 is similar to that of each of the laser 141, the cryptographic generation unit 143, the beam splitter 144, and the balance PD 145 of FIG. 7.

In other words, the cryptographic signal decryption unit 23D in the example of FIG. 9 is different from the cryptographic signal decryption unit 23C shown in FIG. 7 in the following point. Specifically, instead of the optical phase modulator 142, the optical phase modulator 152 and the Mach-Zehnder modulator 153 are employed.

The Mach-Zehnder modulator 153 is a modulator having an interferometer structure in which the input optical signal is divided into two, the divided optical signals are phase-modulated using the optical phase modulator to cause the two modulated optical signals to interfere with each other. The Mach-Zehnder modulator 153 can perform the amplitude modulation. In other words, the optical phase modulator 152 and the Mach-Zehnder modulator 153 and combined and used, thereby achieving both of the phase rotation about the origin and the amplitude shift in the description of FIG. 8. The outlined arrows drawn from the cryptographic generation unit 154 to the optical phase modulator 152 and the Mach-Zehnder modulator 153 indicate that the control is performed based on the cipher generated by the cryptographic generation unit 154. In other words, the optical phase modulator 152 and the Mach-Zehnder modulator 153 performs the modulation in cooperation with each other based on the cipher generated by the cryptographic generation unit 154, which makes it possible to modulate the local light generated by the laser 151. The order of the optical phase modulator 152 and the Mach-Zehnder modulator 153 is not limited to the example of FIG. 9, and may be inverted.

FIG. 10 is a view showing an example different from FIG. 9 among the examples of a configuration for performing the homodyne detection in the decryption of the optical signal of the quadrature amplitude modulation in the optical domain. A cryptographic signal decryption unit 23E of FIG. 10 includes a laser 161, an IQ modulator 162, a cryptographic generation unit 163, a beam splitter 164, and a balance PD 165.

In other words, the function of each of the laser 161, the cryptographic generation unit 163, the beam splitter 164, and the balance PD 165 of FIG. 10 is similar to that of each of the laser 141, the cryptographic generation unit 143, the beam splitter 144, and the balance PD 145 of FIG. 7.

In other words, the cryptographic signal decryption unit 23E in the example of FIG. 10 is different from the cryptographic signal decryption unit 23C shown in FIG. 7 in the following point. Specifically, instead of the optical phase modulator 142, the IO modulator 162 is employed.

The IQ modulator 162 is a modulator having an interferometer structure in which the input optical signal is divided into four, the divided optical signals are phase-modulated using the optical phase modulator to cause the four modulated optical signals to interfere with each other. The IQ modulator 162 can perform the IQ modulation. In other words, the IQ modulator 162 is used, so that the IQ modulation including both of the phase rotation about the origin and the amplitude shift in the description of FIG. 8 is achieved by one IQ modulator. The outlined arrow drawn from the cryptographic generation unit 163 to each phase modulation element of the IQ modulator 162 indicates that the control is performed based on the cipher generated by the cryptographic generation unit 163. In other words, each optical phase modulation element of the IQ modulator 162 performs the modulation in cooperation with each other based on the cipher generated by the cryptographic generation unit 163, which makes it possible to IQ-modulate the local light generated by the laser 161.

As described with reference to FIGS. 9 and 10, selecting the modulation element as appropriate makes it possible to also apply the decryption in the optical domain and the homodyne detection to the optical signal (cryptographic signal) of the modulation scheme other than the phase modulation as described with reference to FIG. 7.

Here, advantages are described in that the modulation is performed not on the optical signal (cryptographic signal) but on the local light for the homodyne detection generated from the laser, as described with reference to FIGS. 7, 9 and 10.

In other words, in a case where the modulation is performed on the optical signal (cryptographic signal), there are disadvantages in that the optical signal (cryptographic signal) attenuates due to the modulation elements or the like and the modulation is influenced by all kinds of noise. On the other hand, in the present embodiment, since the modulation is not performed on the optical signal (cryptographic signal) as described above, the modulation is not attenuated by the modulation elements. This can maintain the signal power of the input optical signal (cryptographic signal). In other words, in the optical reception device 2, it is possible to reduce the influence of the other noises such as thermal noise on the optical signal (cryptographic signal). The signal power loss due to the interposition of the modulation elements for the decryption in the optical domain does not occur. As a result, even in the environment in which the optical transmission loss in the transmission path 3 becomes larger, it is possible to achieve the decryption in the optical domain.

In the detector such as the balance PD, the input power is limited. Accordingly, it is difficult to increase the signal power of the local light by a given level or more to improve the sensitivity. In other words, preventing an attenuation of the signal of the optical signal (cryptographic signal) is an important element for preventing reduction in the sensitivity in the homodyne detection.

In a case where the optical signal (cryptographic signal) is modulated in the cryptographic signal decryption unit 23A shown in FIG. 6, it is necessary to provide a polarization independent modulator (such as an optical phase modulator). On the other hand, since an optical circuit for coherent reception for performing the typical homodyne or heterodyne detection and phase-diversity intradyne detection, the circuit including optical couplers, has a polarization diversity configuration, it is sufficient if only one polarization is modulated in a case where the local light is modulated. This makes it possible to employ a general-purpose optical modulator having polarization dependency, which contributes to cost reduction. The description has been given above regarding the advantage in that the modulation is performed on the local light for the homodyne detection generated from the laser.

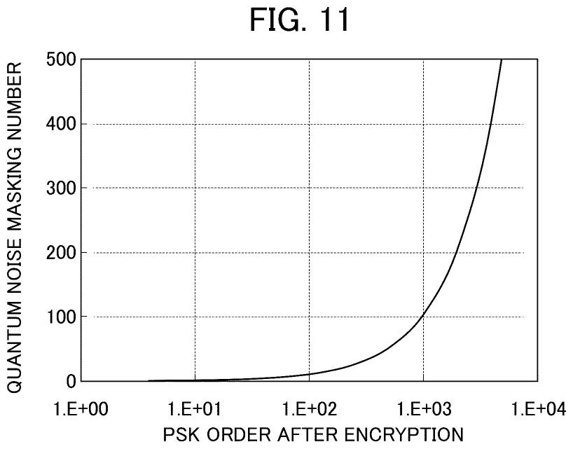

Next, although in the description of Formula (1), when the signal power P0 becomes ½ times, the masking number becomes the square root of 2 times, but a description is given regarding the fact that this makes it possible to relieve the requirements of the modulation number M in the optical transmission device 1. FIG. 11 is a view showing a relationship between the quantum noise masking number and the PSK order after encryption. In other words, the vertical axis corresponds to the masking number in the above description and the horizontal axis corresponds to the modulation number M. A graph shown in FIG. 11 shows an example when P0=2Pmin in Formula (1). The signal power Pmin is a signal power that achieves BER=1×10⁻³ in the homodyne detection.

As seen from FIG. 11, the encryption phase modulation resolution for achieving the masking number of about 10 to 100 required to protect the private key requires 7 to 9 bits (about 256 to 1024 as the PSK order (modulation number M)). On the other hand, although not shown, the PSK order (modulation number M) required to achieve the conventional masking number requires 14 bits or more. Thus, the signal power eavesdropped by the eavesdropper is limited to less than 2Pmin, so that the requirements to increase the number of levels of the optical signal is relieved.

This is not the direct effect of the receiver configuration that modulates and decrypt the local light but the effect by the limitation of the signal power to less than 2Pmin when the eavesdropper eavesdrops the optical signal (to reduce the optical power on the transmitting side or introduce the monitor described later), in other words, the effect as the entire system including transmission and reception.

When the signal power when the eavesdropper eavesdrops the optical signal is limited to less than 2Pmin, the data can be protected with a small PSK order after encryption. As an extreme example, the data can be protected even when the PSK order is 4.

Here, the object to make the PSK order large to some extent is to protect a shared key. As the key (for example, the shared key), one having a length shorter than the data length is normally employed. As described above, even when the eavesdropper acquires the shared key by some means after completion of the communication, it is impossible to decrypt the data after the IQ simultaneous detection. However, if the shared key is acquired during the communication, the homodyne reception becomes possible with the same receiver configuration as the legitimate receiver. For this reason, it is necessary to maintain the masking number of about several tens to several hundreds.

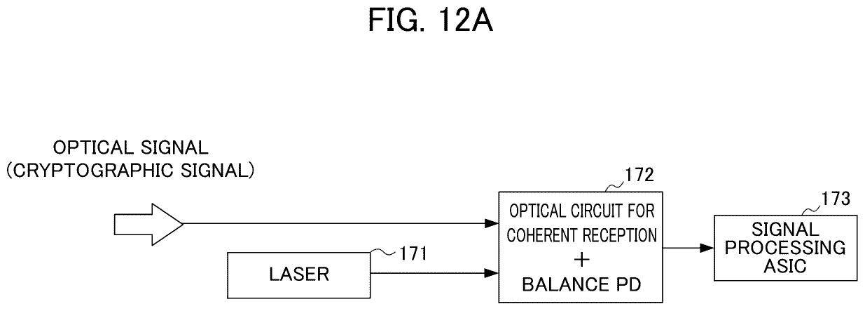

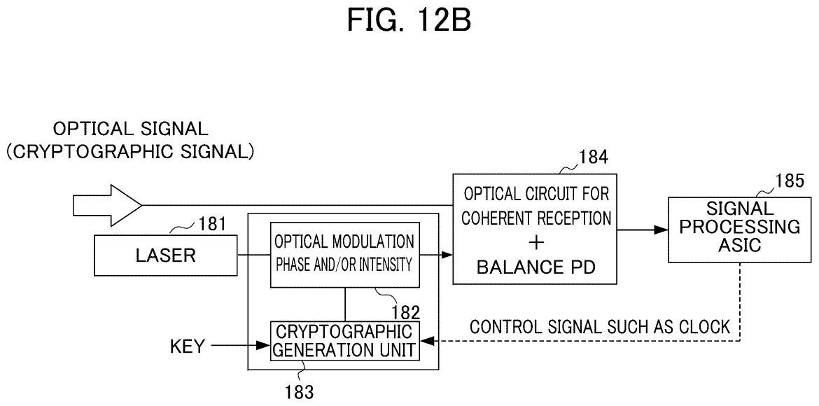

Next, with reference to FIG. 12, a description is given regarding advantages of the decryption in the optical domain with respect to the decryption in the electric domain. FIG. 12 is a view for comparing examples of configurations required for the decryption in the optical domain and the decryption in the electric domain. FIG. 12A shows an example of a configuration of a normal digital coherent optical receiver. The digital coherent optical receiver (optical reception device 2) in the example of FIG. 12A includes a laser 171, an optical circuit for coherent reception and balance PD 172, and a signal processing ASIC 173.

Here, for example, as the optical circuit for coherent reception in the optical circuit for coherent reception and balance PD 172, an optical circuit for coherent reception for performing the homodyne detection and the heterodyne detection may be employed. The optical circuit for coherent reception for performing the homodyne detection and the heterodyne detection includes one optical coupler. For example, an optical circuit for coherent reception for performing the phase-diversity intradyne detection may be employed. The optical circuit for coherent reception for performing the phase-diversity intradyne detection includes four optical couplers and one polarization rotation element. Furthermore, a coherent reception optical circuit independent of incident polarization may be employed that uses the polarization beam splitter to separate each of the signal light and the local light into polarization components orthogonal to each other and performs the homodyne detection or heterodyne detection, or the phase-diversity intradyne detection on the signal light for each polarization component using the local light having the same polarization as the signal light.

In the normal digital coherent optical receiver, the data at the position on the IQ plane that is output by the balance PD 172 is input to the signal processing ASIC 173. As a result, the circuit that decrypts the cipher in addition to the compensation of the waveform distortions by the digital signal processing needs to be implemented in the signal processing ASIC 173. In other words, it is necessary to develop the signal processing ASIC 173 in which the circuit that performs the decryption by the digital signal processing (in other words, the decryption function by the digital signal processing) is implemented. This requires very large cost.

FIG. 12B shows an example of a configuration for the decryption in the optical domain. The optical reception device 2 in the example of FIG. 12B includes a laser 181, an optical modulation phase and/or intensity modulator 182, a cryptographic generation unit 183, an optical circuit for coherent reception and balance PD 184, and a signal processing ASIC 185. Here, the optical modulation phase and/or intensity modulator 182 refers to a modulator that performs at least one of the optical phase modulation and the intensity modulation. Specifically, for example, an arbitrary configuration such as one optical phase modulator, a combination of the optical phase modulator and the Mach-Zehnder modulator, and the IQ modulator may be employed as the and/or intensity modulator 182.

For example, as the optical circuit for coherent reception in the optical circuit for coherent reception and balance PD 184, an optical circuit for coherent reception for performing the homodyne detection and the heterodyne detection may be employed. The optical circuit for coherent reception for performing the homodyne detection and the heterodyne detection includes one optical coupler. For example, an optical circuit for coherent reception for performing the phase-diversity intradyne detection may be employed. The optical circuit for coherent reception for performing the phase-diversity intradyne detection includes four optical couplers and one polarization rotation element. Furthermore, a coherent reception optical circuit independent of incident polarization may be employed that uses the polarization beam splitter to separate each of the signal light and the local light into polarization components orthogonal to each other and performs the homodyne detection or heterodyne detection, or the phase-diversity intradyne detection on the signal light for each polarization component using the local light having the same polarization as the signal light.

Since it is only required that the signal processing ASIC 185 of FIG. 12B subjects the signal after decryption to the processing, the existing optical communication signal processing ASIC can be used. A control signal such as a clock from the existing optical communication signal processing ASIC is fed back to drive the cryptographic generation unit 183, thereby enabling the decryption synchronized with the optical signal (cryptographic signal). In other words, a square portion surrounding the optical modulation phase and/or intensity modulator 182 and the cryptographic generation unit 183 is added on the normal optical communication circuit including the existing optical communication signal processing ASIC, whereby the optical reception device 2 that performs the decryption in the optical domain is achieved. This makes it possible to achieve the optical reception device 2 at low cost.

Next, as described above in FIG. 5, since even when the eavesdropper eavesdrops the signal with the signal power of less than 2Pmin, the signal satisfies the minimum receiving sensitivity or less of the IQ simultaneous detection (heterodyne detection or the like), a description is given regarding the signal processing system using the property of achieving the extremely high security against the eavesdropping (the security equivalent to or exceeding the information-theoretic security). Although the signal power output from the optical transmission device 1 is less than 2Pmin in FIG. 5, a case is considered where the signal is transmitted with the signal power sufficiently larger than 2Pmin. In this case, the eavesdropper branches the signals with the signal power of 2Pmin or more as some of the signal power to eavesdrop the signals. The eavesdropper performs the IQ simultaneous detection on the eavesdropped optical signal (cryptographic signal), and executes the decryption afterward.

When the signal processing system of FIG. 1 is installed, in the case where the eavesdropper branches the signals with the signal power of 2Pmin or more to eavesdrop the signals, it is preferable to introduce a monitor capable of detecting such a fact. In the case where eavesdropping is detected on the monitor, some kinds of measures such as communication cut-off are performed. This makes it possible to ensure the security of the signal.

Thus, on the premise that the countermeasures against eavesdropping using the signal with 2Pmin or more is performed by the monitor, the signal power output from the optical transmission device 1 can be made larger than 2Pmin. This enables transmission of the optical signal (cryptographic signal) via the transmission path 3 having the optical transmission loss of 3 dB or more.

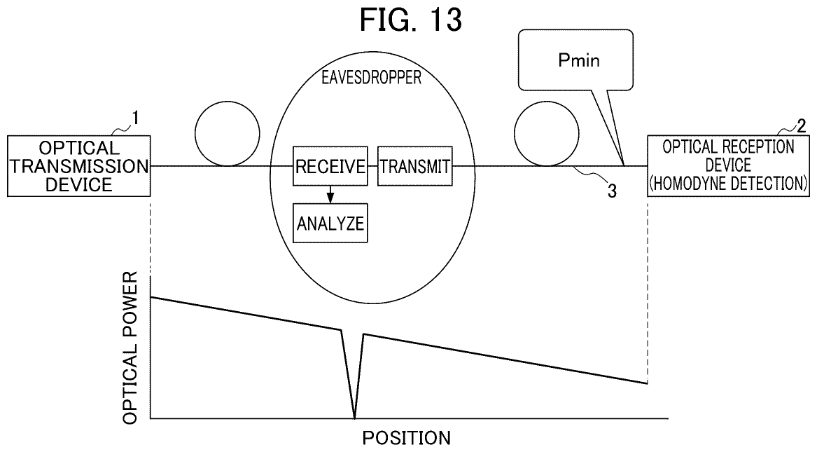

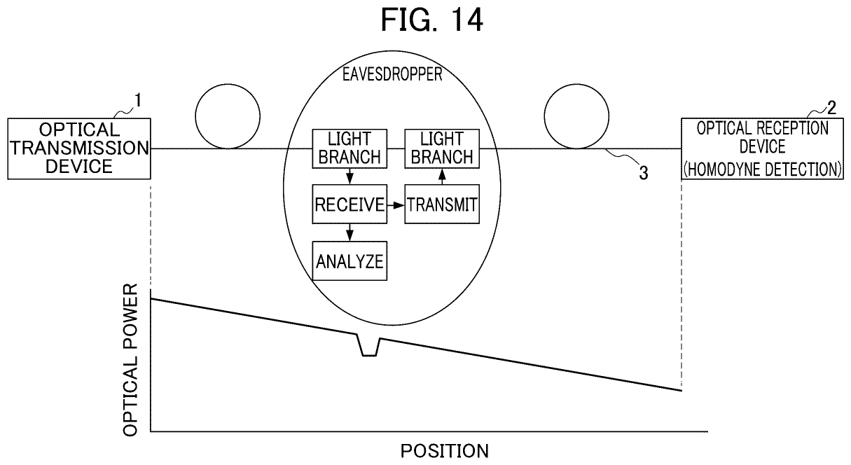

Here, as the monitor, the following one can be employed. In other words, in simple terms, it is only required that a reduction in the signal power or the signal quality (varies depending on the optical power) is detected on the side of the optical reception device 2. This scheme returns such an optical signal by which the power reduction cannot be detected while eavesdropping on the light in the middle, in other words, has a weakened aspect against a so-called man-in-the-middle attack. Here, an example of the man-in-the-middle attack is shown in FIGS. 13 and 14. FIG. 13 is a view showing an example of the man-in-the-middle attack by the eavesdropper. FIG. 14 is a view showing an example of the man-in-the-middle attack by the eavesdropper, the example being different from FIG. 13.

The eavesdropper in the example of FIG. 13 receives (detects) and analyzes all of the optical signals (cryptographic signals) transmitted from the optical transmission device 1, and transmits the optical signals according to the reception (detection) results to perform the man-in-the-middle attack. At this time, the eavesdropper transmits the signal power corresponding to the case where the man-in-the-middle attack is not performed. Thus, the signal power received by the optical reception device 2 is about Pmin, and has the same signal intensity as the original signal intensity described using FIG. 5 and the like. Thus, it is impossible to determine that the man-in-the-middle attack is performed only by monitoring the signal intensity in the optical reception device 2.

The eavesdropper in the example of FIG. 14 branches the optical signals (cryptographic signals) transmitted from the optical transmission device 1 to receive (detect) and analyze some of the optical signals, and transmits the optical signal according to the reception (detection) results while superimposing the branched optical signals on each other to perform the man-in-the-middle attack (tap attack). At this time, the eavesdropper transmits the signal power corresponding to the case where the man-in-the-middle attack is not performed. Thus, the signal power received by the optical reception device 2 is about Pmin, and has the same signal intensity as the original signal intensity described using FIG. 5 and the like. Thus, it is impossible to determine that the man-in-the-middle attack is performed only by monitoring the signal intensity in the optical reception device 2.

Accordingly, the man-in-the-middle attack can be detected by monitoring the distribution of the optical power in the transmission path. Furthermore, it is possible to detect the insertion of light branches in the tap attack shown in FIG. 14. High performance (dynamic range and resolution) is required for such a monitor. However, the light cannot be actually branched with zero loss. Therefore, the detection itself is possible. As a (classical) monitor, the following scheme can be employed. In other words, a scheme of inserting the light serving as a probe from the side of the optical reception device 2 can be employed. For example, a scheme of monitoring the signal power distribution in the transmission path 3 by the digital signal processing from the optical signal itself can be employed. Since this scheme does not require an additional mechanism, this scheme is preferable when being combined with the encryption communication.

Furthermore, although the high performance (dynamic range and resolution) is required for the conventional (classical) monitor, it is preferable to employ a quantum monitor as described below. In other words, the quantum monitor receives weak light showing a remarkable quantum nature (optical signal with large shot noise with respect to the signal power resulting from small signal power) together with the signal light from the optical transmission device 1 or the optical reception device 2. In other words, when the weak light showing a remarkable quantum nature is received (detected), large shot noise occurs with respect to the signal power. The eavesdropper cannot reproduce the weak light except for the shot noise. For this reason, the optical signal in which the shot noise occurs is transmitted. As a result, when the weak light is received, the signal intensity of the weak light is different from the expected one. This makes it possible to reliably detect the man-in-the-middle attack (tap attack). Furthermore, as described above, in this signal processing system, a cryptographic scheme is employed that can improve the cryptographic intensity by reducing the intensity of the optical signal (cryptographic signal) transmitted from the optical transmission device 1. Accordingly, it is preferable to employ a scheme of multiplexing to transmit the optical signal (cryptographic signal) and the weak light of the quantum monitor.

Here, the advantages of the configuration of the optical reception device 2 described above and each component will be summarized. First, in the optical reception device 2, it is preferable to employ a configuration in which the decryption in the optical domain is performed. When the decryption in the optical domain is performed, the decrypted optical signal is detected without detecting the optical signal (cryptographic signal) as is, which makes it possible to employ the existing optical communication elements and electronic circuit. This facilitates manufacture of the optical reception device 2, which enables cost reduction.

Next, in the optical reception device 2, it is preferable to employ the detection scheme of modulating the local light from the laser to cause the modulated local light interfere with the optical signal (cryptographic signal) as the decryption in the optical domain. Specifically, for example, in the optical reception device 2, it is preferable to employ the coherent detection scheme such as homodyne detection, heterodyne detection, or phase-diversity intradyne detection and to employ a configuration that performs at least one of the phase modulation and the intensity modulation on the local light. Thus, the optical signal (cryptographic signal) does not undergo an attenuation due to the modulation elements. Thus, since portions other than the transmission path 3 does not undergo an attenuation, better detection results can be obtained.

Furthermore, in the optical reception device 2, it is preferable to employ the homodyne detection. In other words, the legitimate receiver that can perform the demodulation in the optical domain can employ the homodyne detection, but the eavesdropper needs to perform the IQ simultaneous detection, and therefore the homodyne detection cannot be employed. In the homodyne detection, the receiving sensitivity is higher by 3 dB as compared with other detection schemes. This makes it possible for the legitimate receiver to obtain good detection results as compared with the eavesdropper.

Furthermore, when the minimum receiving sensitivity in the homodyne detection of the optical reception device 2 is defined as the signal power Pmin, it is preferable that the signal power at the time of transmission in the optical transmission device 1 is less than 2Pmin. This makes it possible to ensure the extremely high security (the security equivalent to or exceeding the information-theoretic security) against the eavesdropper that performs the detection schemes other than the homodyne detection. In other words, even when any digital signal processing for the decryption is performed after the IQ simultaneous detection, the eavesdropper cannot decrypt the correct data.

When the eavesdropper branches and eavesdrops the signal with 2Pmin or more between the optical transmission device 1 and the optical reception device 2, it is preferable to introduce a monitor capable of detecting such a fact. This makes it possible to set the signal power at the time of transmission in the optical transmission device 1 to 2Pmin or more. Thus, even when the optical transmission loss in the transmission path 3 is 3 dB or more, the optical signal (cryptographic signal) can be transmitted and received while ensuring the security.

It is preferable to employ, for the monitor, the scheme of monitoring the signal power distribution in the transmission path 3 by the digital signal processing from the optical signal itself. It is preferable to employ, for the monitor, a scheme of multiplexing to transmit the weak light of the quantum monitor.

As described above, various embodiments of the signal processing system to which the present invention is applied have been described. However, it is sufficient if the signal processing system to which the present invention is applied achieves the feature of “not allowing an eavesdropper to correctly obtain ciphertext due to effects of quantum noise”, in other words, the encryption is performed in the physical layer and the convenience of the countermeasures against eavesdropping in the physical layer is improved, and the configuration is not limited to the various embodiments described above, and may be as follows.

For example, in the embodiments described above, for the convenience of the description, the transmission path 3 is employed as the transmission path for the optical signal transmitted from the optical transmission device 1 and received by the optical reception device 2, but there is no particular limitation to this. In other words, the description has been given using the optical communication cable as an example of the transmission path 3, but there is no particular limitation to this. In other words, the transmission path 3 is not limited to something that uses an optical fiber, and may comprise a communication path such that propagation is performed over a so-called optical wireless space. Specifically, for example, a vacuum space including air, water, and universe may be employed as the optical transmission path. In other words, any communication channel may be used between the optical communication cable 3 and the optical transmission device 1 or the optical reception device 2.

Furthermore, for example, the transmission data provision unit 11 is incorporated in the optical transmission device 1, and the transmission data may be received from outside of the optical transmission device in accordance with a predetermined reception unit that is wired or wireless, by providing the transmission data reception unit (not shown). Furthermore, a storage device (not shown) or removable media may be used to provide the transmission data. In other words, the transmission data provision unit may have any kind of transmission data acquisition unit.

For example, the cryptographic key provision units 12 and 22 may provide a key sufficient to generate multi-level data relating to encryption by the cryptographic signal generation unit. In other words, the cryptographic key may be a shared key, and may be a key that uses a different algorithm such as a private key and a public key.

For example, the laser does not need to be incorporated in the optical reception device 2. In other words, the optical reception device 2 may be an optical signal decryption device that is inputted with local light for detection and decrypts a cryptographic signal.

For example, in the embodiments described above, for the convenience of the description, the modulation is performed using one optical phase modulator, a combination of the optical phase modulator and the Mach-Zehnder modulator, and the IQ modulator, but there is no particular limitation to this. The modulation may be performed on any path of an interferometer configuration that branches into any number of paths, and the modulated signal may be subject to interference any number of times at any location. Furthermore, other interferometer structures may be provided behind the interferometer configuration. In other words, for example, a Mach-Zehnder modulator cascaded in multiple stages or an IQ modulator cascaded in multiple stages may be used.

Furthermore, for example, in the embodiments described above, predetermined data to be transmitted is defined as multi-level information based on the protocol of the Y-00 optical communication quantum cryptography as a predetermined protocol, but there is no particular limitation to this. In other words, in the embodiments described above, as described with reference to FIGS. 2 and 3, when being modulated into a multi-level, each symbol point is evenly distributed. However, it is not necessary to distribute each symbol point evenly. It is sufficient if the modulation is performed to satisfy the requirement that the distance between at least one set of symbol points among sets of adjacent symbol points is sufficiently smaller than a range of various kinds of noise including the shot noise. In other words, in the case where the optical signal is transmitted in association with any two symbol points among a plurality of symbol points, it is sufficient if the optical signal associated with the two symbol points is a predetermined protocol detected as the same position on the IQ plane.

To summarize the above, it is sufficient if a signal processing system to which the present invention is applied is as follows, and various embodiments can be taken. In other words, a signal processing system (for example, the optical transmission device 1 in FIGS. 7, 9, and 10) to which the present invention is applied comprises:
a transmission unit (for example, the optical transmission device 1 in FIGS. 7, 9, and 10) that modulates laser light to transmits, as a first optical signal, the laser light at a first intensity to detect the laser light at the same position as an optical signal associated with another symbol point on an IQ plane when N values of transmission information (where N is an integer value of 2 or more) correspond to M symbol points (where M is an integer value greater than N) in accordance with a predetermined protocol and an optical signal associated with a predetermined symbol point is received; a reception unit (for example, the cryptographic signal reception unit 21 in FIG. 1) that receives a first optical signal and a second optical signal via a path;
an acquisition unit (for example, an input unit of a beam splitter in FIGS. 7, 9, and 10) that acquires, as a third optical signal, a laser modulated in accordance with the predetermined protocol for demodulation; and
a demodulation unit (for example, a demodulation unit including the beam splitter and the balance PD in FIGS. 7, 9, and 10) that demodulates transmission information using a scheme of causing the second optical signal and the third optical signal to interfere with each other to perform the demodulation,
wherein it is sufficient if the first intensity is less than two times the second intensity that is a lower limit at which the second optical signal is able to be demodulated. Thus, even when the eavesdropper eavesdrops the optical signal between the transmission unit and the reception unit, the security can be ensured so that the eavesdropper cannot decrypt the optical signal in any way.

Furthermore, the predetermined protocol can be a protocol for determining a modulation amount based on a key, and the third optical signal can be modulated and generated by a modulation element causing a laser of local light to be modulated by the modulation amount. Thus, since the modulation on the second optical signal is not performed, an attenuation of the second optical signal does not occur, whereby better demodulation is performed.

EXPLANATION OF REFERENCE NUMERALS

1 optical transmission device, 2 optical
reception device, 3 transmission path, 11 transmission
data provision unit, 12 cryptographic key provision unit,
13 cryptographic signal generation unit, 14
cryptographic signal transmission unit, 21 cryptographic
signal reception unit, 22 cryptographic key provision
unit, 23 cryptographic signal decryption unit, 24, 24A to
24E cryptographic signal decryption unit, 25 reception
data management unit, 101 electric decryption unit, 111
optical decryption unit, 112 detection unit, 121
detection unit, 122 electric decryption unit, 131
laser, 132 beam splitter, 141 laser, 142 optical
phase modulator, 143 cryptographic generation unit, 144
beam splitter, 151 laser, 152 optical phase
modulator, 153 Mach-Zehnder modulator, 154
cryptographic generation unit, 155 beam splitter, 161
laser, 162 modulator, 163 cryptographic generation
unit, 164 beam splitter, 171 laser, 172 173
optical circuit for coherent reception and balance PD, 181
laser, 182 intensity modulator, 183 cryptographic
generation unit, 184 optical circuit for coherent
reception and balance PD, 185 signal processing ASIC

1. A signal processing system, comprising:
a transmission unit that modulates laser light to transmit, as a first optical signal, the laser light at a first intensity to detect the laser light as an optical signal associated with another symbol point on an IQ plane when N values of transmission information (where N is an integer value of 2 or more) correspond to M symbol points (where M is an integer value greater than N) in accordance with a predetermined protocol and an optical signal associated with a predetermined symbol point among the M symbol points is received;
a reception unit that receives a first optical signal and a second optical signal via a path;
an acquisition unit that acquires, as a third optical signal, a laser modulated in accordance with the predetermined protocol for demodulation; and
a demodulation unit that demodulates transmission information using a scheme of causing the second optical signal and the third optical signal to interfere with each other to perform the demodulation.

2. The signal processing system according to claim 1, wherein
the predetermined protocol is a protocol for determining a modulation amount based on a key, and
the third optical signal is modulated and generated by a modulation element causing a laser of local light to be modulated by the modulation amount.

3. The signal processing system according to claim 1, wherein the first intensity is less than two times the second intensity that is a lower limit at which the second optical signal is able to be demodulated.
